(19) United States
(12) Patent Application Publication
(10) Pub. No.: US 2021/0347571 A1
(43) Pub. Date: Nov. 11, 2021

(54) PERSONAL PROTECTIVE EQUIPMENT TOOLS AND METHODS OF USE FOR MANIPULATING A HANDLE

(71) Applicant: Andrew Wagner, Elm City, NC (US)

(72) Inventor: Andrew Wagner, Elm City, NC (US)

(21) Appl. No.: 16/869,628

(22) Filed: May 8, 2020

(51) Int. Cl. B65G 7/00; A44B 13/00; A45F 5/00

(52) U.S. Cl. CPC B65G 7/00; A45F 2200/0575; A45F 5/00; A44B 13/0029

(57) ABSTRACT

Personal protective equipment tools and methods of use for manipulating a handle are disclosed. According to an aspect, a tool includes a base defining a first side and a second side. The first side is configured for conforming to an arm of a person. The second side substantially opposes the first side. The tool also includes one or more grabber components that are attached to the second side of the base and configured to grab a handle. The tool also includes an attachment mechanism attached to the base and being configured to affix the base to the arm of the person.

### TECHNICAL FIELD

The presently disclosed subject matter relates generally to personal protective equipment. Particularly, the presently disclosed subject matter relates to personal protective equipment tools and methods of use for manipulating a handle.

### BACKGROUND

Pathogens can be transmitted through the air over time and distance by small particles to deliver airborne disease to humans. In this manner, such pathogens can spread disease to a human from another human or another source. For example, they may be spread through breathing, talking, coughing, sneezing, raising of dust, spraying of liquids, toilet flushing, or any activities which generate aerosol particles or droplets. Further, in some instances, the pathogens may attach to a surface that is touched by a human to thereby spread to that human.

Personal protective equipment have been developed to protect humans from pathogens on surfaces. For example, a person can wear gloves to protect from contaminated surfaces. These wearable items have routinely been used in healthcare settings, such as hospitals, laboratories and factories, but more recently the usage of personal protective equipment has extended to public places such as grocery stores, gas service stations, retail stores, restaurants, parks, and sporting events.

Recently, there is a greater interest in the use of personal protective equipment for protection against contaminants, such as pathogens or other harmful particles, that reside on surfaces often touched by humans such as handles. There is a desire to provide improvements in the effectiveness and convenience of protecting humans from surface contaminants.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a perspective view of a personal protective equipment tool for manipulating a handle in accordance with embodiments of the present disclosure;

FIG. 2 is a perspective view of the tool shown in FIG. 1 with an attachment mechanism for affixing the tool to a person's arm being included in accordance with embodiments of the present disclosure;

FIG. 3 is a perspective view of the tool affixed to an object representative of a person's forearm and in use for manipulating a handle of a door in accordance with embodiments of the present disclosure;

FIG. 4 is a top view of the tool engaging the handle shown in FIG. 3;

FIG. 5 is a front view of the tool shown in FIGS. 1-3 without the straps attached; and

FIG. 6 is a perspective view showing the tool engaging a handle of another type than the type shown in FIGS. 3 and 4.

### SUMMARY

The presently disclosed subject matter provides personal protective equipment tools and methods of use for manipulating a handle. According to an aspect, a tool includes a base defining a first side and a second side. The first side is configured for conforming to an arm of a person. The second side substantially opposes the first side. The tool also includes one or more grabber components that are attached to the second side of the base and configured to grab a handle. The tool also includes an attachment mechanism attached to the base and being configured to affix the base to the arm of the person.

According to another aspect, a method for using a tool to manipulate a handle includes providing a tool having a base defining a first side and a second side. The second side substantially opposes the first side. The tool also includes one or more grabber components attached to the second side of the base. Further, the tool includes an attachment mechanism attached to the base. The method also includes using the attachment mechanism to attach the base to an arm of a person such that the first side faces the arm of the person. Further, the method includes moving the tool such that the grabber component engages a handle for manipulation of the handle.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

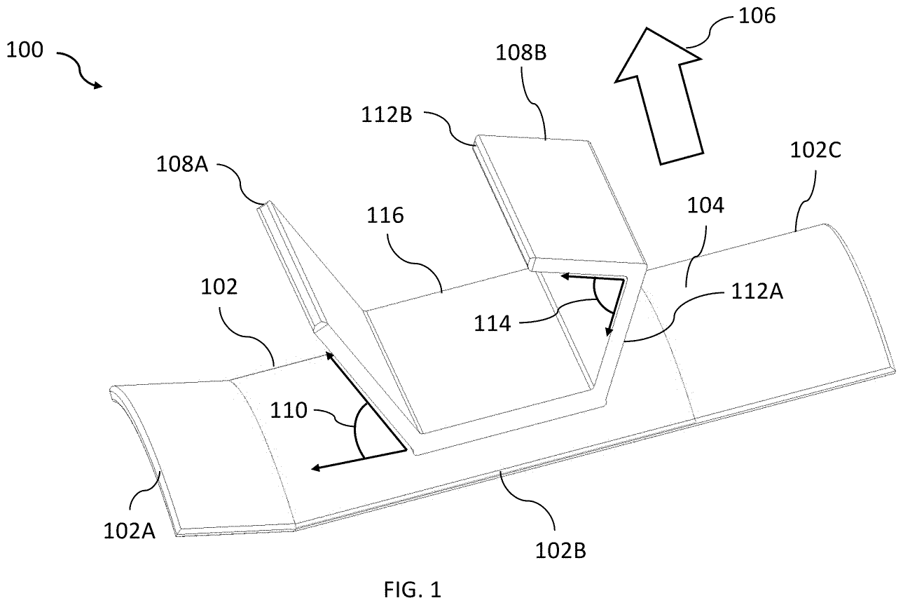

FIG. 1 illustrates a perspective view of a personal protective equipment tool 100 for manipulating a handle in accordance with embodiments of the present disclosure. Referring to FIG. 1, the tool 100 includes a base 102 that defines a top side 104 and an opposing bottom side (not shown in FIG. 1). The opposing side is configured for conforming to an arm of a person. Particularly, the opposing side can be concave in shape or another suitable shape and dimension such that it conforms to the curvature of a forearm of a person. The length of the base 102 can range between about 3 inches and about 11 inches. Further, the base 102 can have a width between about 2 inches and about 4 inches.

In this example, the base 102 includes three main components 102A, 102B, and 102C that are substantially rectangular in shape and curved as shown. However, it is noted that the base 102 may include any suitable number of components having size, dimension, and shape for implementing the functionality described herein. The base 102 may be made of plastic or any other suitable material. The base 102 is substantially elongated in shape and extends between the ends defined by components 102A and 102C.

The tool 100 may include an attachment mechanism not shown in FIG. 1 in order to better show the base 102. The attachment mechanism may include one or more straps that are suitably connected to components 102A, 102B, and/or 102C for attaching the base 102 to a person's forearm such that the tool 100 can be worn by the person. In an example, a strap may be a hook and loop fastener as will be appreciated by those of skill in the art. As shown components 102A and 102C are angled in an upward direction (indicated by arrow 106) from the component 102B in order to help with preventing the straps from moving off of the base 102 so that the tool remains securely attached to the forearm.

The tool 100 also includes grabber components 108A and 108B that are attached to the top side 104 of the body 102. Although two grabber components having particular sizes, shapes, and dimensions are shown in this example, it should be appreciated that any number of grabber components of any suitable size, shape, and dimension may be attached to the body for implementing the functionality described herein. The grabber components 108A and 108B extend away from the base 102 substantially in the direction indicated by arrow 106.

The grabber component 108A in this example is substantially rectangular in shape. Further, it extends from the top surface 104 at an angle, generally indicated by reference 110, from its attachment to the top side 104 of the base 102. The angle can be in the range of between about 45 degrees and about 90 degrees. As a result, grabber component 108A forms a lever with the base 102 for use by a person wearing the tool 100 for moving a handle.

The grabber component 108B includes a first portion 112A and a second portion 112B. The first portion 112A has one end attached to the top side 102 and a distal end to where the first portion 112A extends from the top side 102. At this distal end, the first portion 112A is connected to an end of the second portion 112B. The second portion 112B extends from where it connects to portion 112A to its distal end along a direction, which is different than the direction that the first portion 112A extends from the base 102. The first portion 112A and the second portion 112B are angled with respect to each other in this way such that the grabber component 112B forms a hook with the base 102 for use by a person wearing the tool 100 to move a handle. This angle is indicated by reference 114 and can be in the range of between about 45 degrees and about 115 degrees.

With continuing reference to FIG. 1, it is noted that the tool 100 may include a support structure 116 for supporting attachment of the grabber components 108A and 108B to each other and/or to the base 102. As shown in FIG. 1, the support structure 116 is rectangular in shape but may alternatively be any other suitable size, dimension, or shape. The support structure 116 is attached to the base 102.

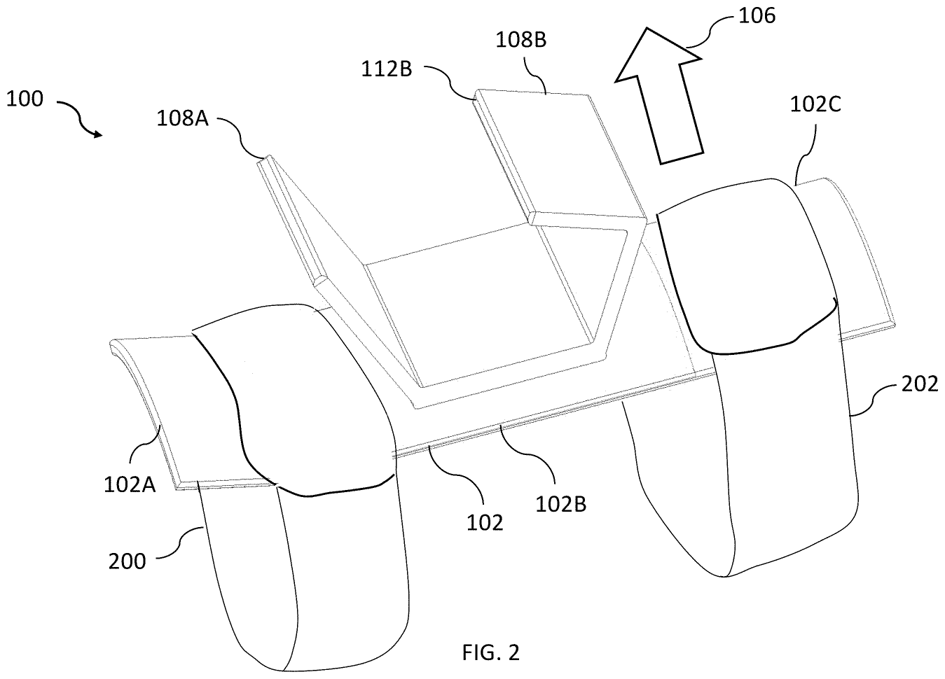

FIG. 2 illustrates a perspective view of the tool 100 shown in FIG. 1 with an attachment mechanism for affixing the tool 100 to a person's arm being included in accordance with embodiments of the present disclosure. Referring to FIG. 2, the attachment mechanism in this example includes straps 200 and 202. The straps 200 and 202 may be any suitable type of strap for affixing the base 102 to a person's arm, particularly the forearm of a person. In this way, the base 102 is stabilized by attachment to the person's arm, and the person can maneuver his or her arm to position one or both of the grabber components 108A and 108B to engage a handle and then move the grabber components 108A and/or 108B to move the handle as desired, such as to open or close a door to which the handle is attached. In this example, the straps are hook and loop fasteners, such as the hook and loop fasteners known by the VELCRO® trademark name. As shown, the straps 200 and 202 are looped around the ends of portions 102A and 102C, respectively, for attaching to these ends of the base 102. The straps 200 and 202 may be suitably loosened for fitting to a person's forearm, adjusted, and secured for securely affixing to the person's forearm. In this way, the straps 200 and 202 can be affixed to different portions of the person's forearm to stabilize the base 102.

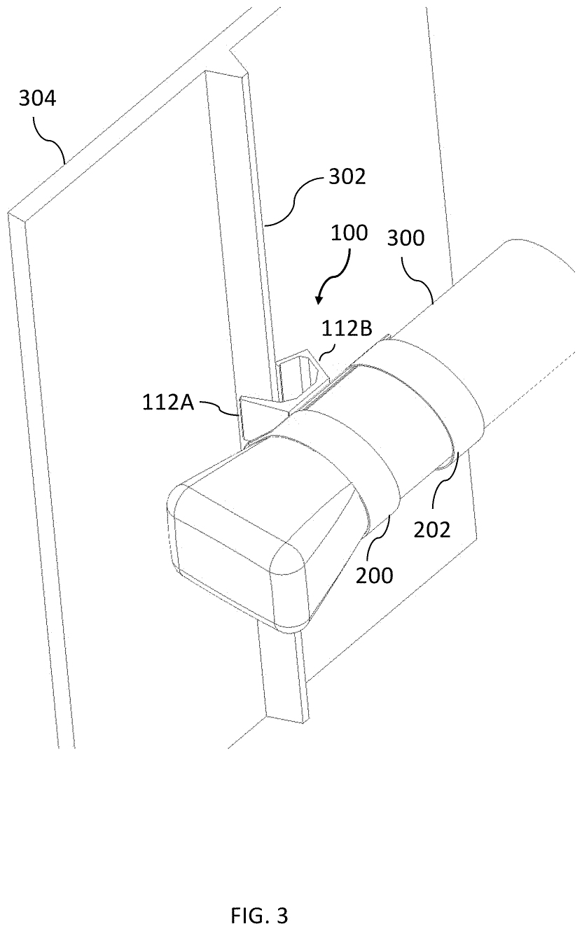

FIG. 3 illustrates a perspective view of the tool 100 affixed to an object 300 representative of a person's forearm and in use for manipulating a handle 302 of a door 304 in accordance with embodiments of the present disclosure. Referring to FIG. 3, the tool 100 is affixed to the object 300 by straps 200 and 202 being wrapped and secured around the base of the tool 100 and also to different portions of the object 300. Thereby, the object 300 can move to manipulate movement of grabber components 112A and 112B. In this example, the grabber components 112A and 112B are positioned to engage the handle 302 such that further movement of the object 300 can cause the handle 302 to be moved. For example, the handle 302 can be pulled or otherwise urged to movement by the grabber components 112A and 112B such that the door 304 is opened or closed.

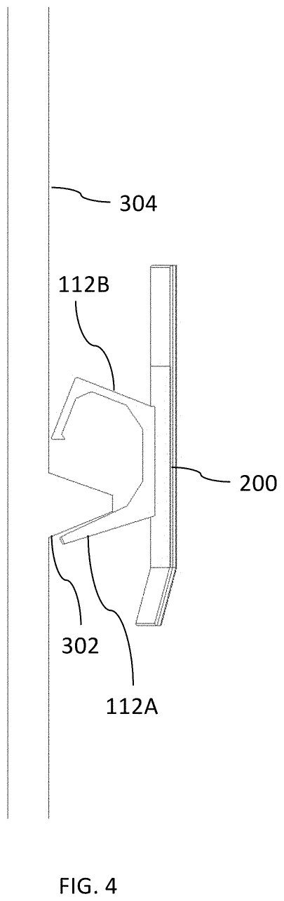

FIG. 4 illustrates a top view of the tool 100 engaging the handle 302 shown in FIG. 3. For purpose of clarity, the figure does not show the object 300 and straps 200 and 202 shown in FIG. 3. Referring to FIG. 4, the grabber component 112A may engage the handle 302 and the grabber component 112B may engage the facing surface of the door 304 for applying leverage to open or close the door.

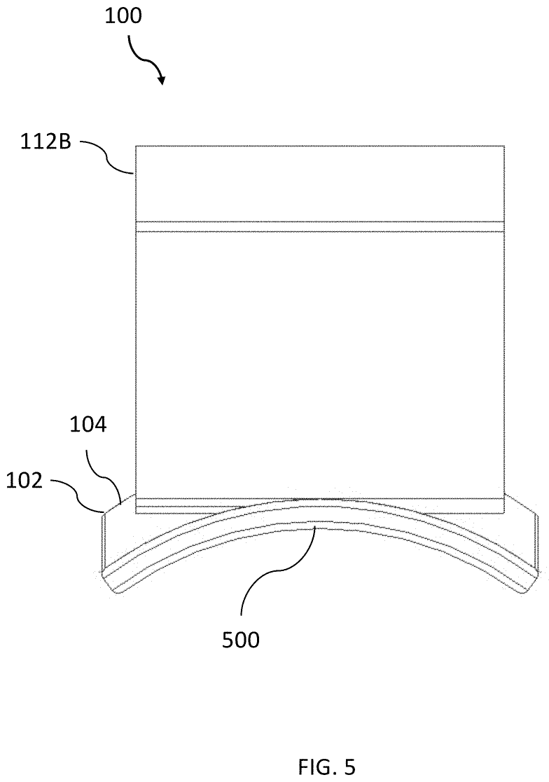

FIG. 5 illustrates a front view of the tool 100 shown in FIGS. 1-3 without the straps attached. Referring to FIG. 5, the figure shows the bottom side 500 of the base 102 that opposes the top side 104. The concave contour of the bottom side 500 is shown for fitting to the curvature of an arm of a person.

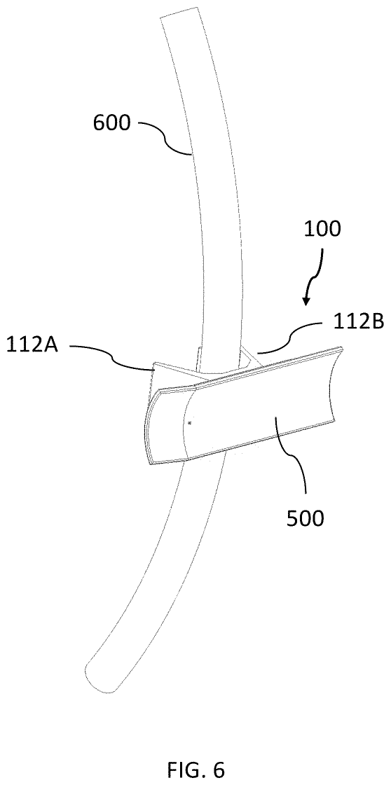

FIG. 6 illustrates a perspective view showing the tool 100 engaging a handle 600 of another type than the type shown in FIGS. 3 and 4. Referring to FIG. 6, the grabber components 112A and 112B are shown as contacting the handle 600 such that the handle 600 can be pulled or pushed for closing a door (not shown) to which it can be attached.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A tool for manipulating a handle, the tool comprising:
a base defining a first side and a second side, wherein the first side is configured for conforming to an arm of a person, and wherein the second side substantially opposes the first side;
at least one grabber component being attached to the second side of the base and being configured to grab a handle; and
an attachment mechanism attached to the base and being configured to affix the base to the arm of the person.

2. The tool of claim 1, wherein the base is substantially elongated in shape.

3. The tool of claim 1, second side of the base is concave in shape.

4. The tool of claim 1, wherein a length of the base is between about 3 inches and about 11 inches.

5. The tool of claim 1, wherein a width of the base is between about 2 inches and about 4 inches.

6. The tool of claim 1, wherein the at least one grabber component comprises a first grabber component and a second grabber component that each substantially extend from their respective attachments to the second side of the base.

7. The tool of claim 1, wherein the at least one grabber component comprises a grabber component that extends at an angle from its attachment to the second side of the base.

8. The tool of claim 7, wherein the angle is a range of between about 45 degrees and about 90 degrees.

9. The tool of claim 7, wherein the grabber component is angled with respect to the base such that the grabber component forms a lever with the base for use by the person to move the handle.

10. The tool of claim 1, wherein the at least one grabber component comprises a grabber component including a first portion and a second portion,
wherein the first portion has a first end and a second end, wherein the first end is attached to the second side of the base, wherein the first portion extends from the base component along a first direction, and
wherein the second portion is attached the second end of the first portion and extends in a second direction that is a different direction than the first direction.

11. The tool of claim 10, wherein the first portion and the second portion are angled with respect to each other such that the grabber component forms a hook with the base for use by the person to move the handle.

12. The tool of claim 11, wherein the angle is a range of between about 45 degrees and about 115 degrees.

13. The tool of claim 1, wherein the attachment mechanism comprises at least one hook and loop fastener being configured to affix the base to the arm of the person.

14. The tool of claim 1, wherein the base is substantially elongated in shape and includes a first and second end, and
wherein attachment mechanism comprises a first hook and loop fastener and a second hook and loop fastener being attached to the first end and the second end, respectively, of the base for affixing the base to different portions of the arm of the person.

15. The tool of claim 1, wherein the attachment mechanism comprises a plurality of straps attached to the base and being configured to affix the base to the arm of the person.

16. A method for using a tool to manipulate a handle, the method comprising:
providing tool comprising:
a base defining a first side and a second side, wherein the second side substantially opposes the first side;
at least one grabber component being attached to the second side of the base; and
an attachment mechanism attached to the base;
using the attachment mechanism to attach the base to an arm of a person such that the first side faces the arm of the person; and
moving the tool such that the at least one grabber component engages a handle for manipulation of the handle.

17. The method of claim 16, wherein the at least one grabber component comprises a first grabber component and a second grabber component that each substantially extend from their respective attachments to the second side of the base.

18. The method of claim 16, wherein the at least one grabber component comprises a grabber component that extends at an angle from its attachment to the second side of the base.

19. The method of claim 18, wherein the grabber component is angled with respect to the base such that the grabber component forms a lever with the base for use by the person to move the handle.

20. The method of claim 16, wherein the at least one grabber component forms a hook with the base for use by the person to move the handle.
